(19) United States
(12) Patent Application Publication
(10) Pub. No.: US 2015/0040477 A1
(43) Pub. Date: Feb. 12, 2015

(54) AQUAPONIC GROWTH BUCKET

(71) Applicants: Shumin Wang, South Pasadena, CA (US); Zhenyan Xu, Yantai (CN)

(72) Inventors: Shumin Wang, South Pasadena, CA (US); Zhenyan Xu, Yantai (CN)

(21) Appl. No.: 13/960,504

(22) Filed: Aug. 6, 2013

(51) Int. Cl. A01G 31/02

(52) U.S. Cl. CPC A01G 31/02
USPC 47/62 N; 47/62 R; 47/59 R

(57) ABSTRACT

A device for growing vegetables and plants in aquaponic conditions is disclosed. The device includes a plurality of sheets, each having an inner surface and an outer surface. The plurality of sheets includes a plurality of protruded openings at the outer surface. The plurality of sheets are attached together and then rolled up to form a container like structure for growing plants. The plant seeds are inserted into the plurality of protruded openings. Then water is sprayed inside the container like structure directed away from the center and nutrients are sprayed directly to the roots of the plants. The device provides growth of plants in shorter time and maximum growing area in limited footage.

### BACKGROUND OF THE INVENTION

1. Technical Field of the Disclosure

The present embodiment is related in general to systems for growing plants, and in particular to a system for increased plant growth in shorter time periods without using soil or an aggregate medium.

2. Description of the Related Art

Aquaponics systems are those which are suitable for use in arid environments due to the low water requirements. Aquaponics is a form of sustainable agriculture that combines fish and plants in a closed re-circulating system. In the aquaponics system, the ammonia generated by fish is naturally converted into nitrates that are used by plants for vigorous growth. The plants filter the water for the fish, and the cycle repeats. Modern aquaponics systems require just 10% the amount of water used in traditional farming (some just 2%). This makes aquaponics particularly appealing in arid regions where water conservation is a priority. The goal in using an aquaponics system is to increase production while minimizing nutrient inputs and the consumption of water. The plants act as a filter for the water, which minimizes total consumption of water throughout the growing season because it is continually recycled throughout the system and does not need to be replaced with new, clean water.

The currently available aquaponics systems tend to be bulky and occupy large space that consumes significant laboratory, greenhouse or warehouse space, or at least requires a large back yard for home system. Such systems are industrial in appearance and operation and would be neither practical nor appealing for installation within a customer-service business, such as a restaurant or market, in a home, or in a small yard. They are also not appropriate for use in classrooms, where aquaponics systems can provide hands-on demonstrations for teaching children everything from basic agriculture principles, e.g., seed-to-table, to biological phenomena such as the nitrogen cycle.

There are different variations of aquaponics systems. One technique uses a continuous flow of a thin layer, or film of water to deliver nutrients to the plants. The plants are placed on a trough and a thin layer of water is pumped to the trough and a continuous supply of nutrients is provided for the plants. The media in which the plants are grown absorb the water as it flows down the trough and delivers it to the plant roots. The water that is not absorbed by the media is returned to the fish tanks with more tolerable levels of nutrients that will not kill the fish. Some water is lost due to transpiration and evaporation at the leaf surface. Water from the bottom trough is pumped up to the upper two levels, where a thin layer of water flows down and returns back to the bottom trough on the opposite side. However, this system is bulky and requires more space.

Another technique requires troughs containing water at foot level. A “raft”-like structure containing individual pots with the designated media float on the water so roots grow directly into the water. Seedlings can be started in pots out of the system and after they germinated, are placed in the raft's net pots or started directly in the rafts in the troughs. The water from the bottom trough is pumped up to the upper troughs through a pipe. The water enters at one corner and drains out of the opposite corner. This system is complex and bulky in construction. Moreover, this system is requires more space.

Similarly, a conventional method discloses the use of mats that produce decorative flower beds in towns. It is necessary to conceal the top surface of the bags by mulching i.e. by laying down a decorative top layer. In the manufacture of soilless growth mats, industries in which a set of sleeves each made from strips of flexible material attached together at their lateral edges and containing a growth substrate is made by a machine. The method includes cutting. the sleeves to the required dimensions and then installing them at the required place. The disadvantage of this method is that transportation to and installation on a site is difficult because of the length of the sleeves. Another disadvantage is that the method uses tools that are costly, heavy and bulky tools that are inconvenient to use. In this method, prefabrication of the mats is highly expensive.

Yet another existing system discloses a vertical garden system for growing plants and filtering air and water which comprises a support structure, a composite, grow media configured to physically support the growth of plants and distribute water to the roots of the plants through capillary action through the area of the grow media, a water source coupled to the grow media through a pump and plumbing system. The plumbing system is configured to draw water from the water source through the grow media and back to the water source in substantially closed loop aquatic system. An air flow subsystem configured to draw outside air through the plants and transmit filtered air back out of the support structure. However, this system is not flexible in shape and not extendable to different sizes.

Another existing system discloses an aquaponics system which includes a tank for housing at least one aquatic animal species, a plant growing apparatus for housing one or more plant species growing in an aqueous environment, a bio-filter module that includes solids removal means and a biological waste digestion unit including a biological species for digesting solids to produce plant nutrients. Plant nutrients are transferred to the plant growing apparatus and at least a portion of the water is returned to the tank. This system is more complex and bulky. The system is not flexible and not extendable to different sizes.

Based on the foregoing, there is a demonstrable need for a system for growing plants that would provide vertical growth of plants and maximum growing area in limited footage. Such a needed system would provide high strength and durability for growth of plants and vegetables. The system would provide flexibility in size and portability. Further, the system would provide a plant container that would be manufactured readily and economically. The system would provide a container that would be extendable to different sizes. The system would also increase the weight per plant in shorter time. Finally, the system would be cost effective, reduces labor cost and convenient for usage. The present invention overcomes prior art shortcomings by accomplishing these critical objectives.

### SUMMARY OF THE INVENTION

To minimize the limitations found in the prior art, and to minimize other limitations that will be apparent upon the reading of the specifications, the preferred embodiment of the present invention provides a device for growing plants in an aquaponics environment.

The present invention discloses a device for growing plants and increases the growth size of plants in shorter time. The preferred embodiment of the device for growing plants comprises a plurality of sheets having an outer surface and an inner surface. The plurality of sheets are attached together and then rolled up to form a container like structure. The plurality of sheets includes a plurality of openings at the outer surface of the container like structure. The plant seeds are inserted into the plurality of protruded openings. Then water is sprayed inside the container like structure directed outwardly. Further, nutrients are sprayed directly to the roots of the plants. The nutrients which are sprayed to the roots of the plants may be bio-fertilizers.

One embodiment of the invention is a fish bowl which is placed at the bottom for catching water dripped from the container like structure. The dripped water contains bacteria that are useful for the growth of the fish. The fish uses the bacteria thereby providing cleaning of water. The ammonia generated by fish is naturally converted into nitrates that are used by plants for vigorous growth and the cycle is repeated.

The present invention provides the growth of vegetables and plants where no soil or aggregate medium is required. The invention is used in combination with aeroponics and aquaponics. The device provides high strength and durability particularly for the production of vegetables. The device provides vertical growth of plants in lesser time. The device is readily and economically manufactured. The invention is advantageous than other organic systems.

The device does not require large space, simple in appearance and built easily. The device is extendable and converted to different sizes by attaching the plurality of sheets. The device is cost effective and convenient for use. The device provides high strength and durability particularly for the production of vegetables. The device is readily and economically manufactured.

A first objective of the present invention is to provide a device that would provide increased growth of plants in shorter time.

A second objective of the present invention is to provide a device that would provide maximum growing area in limited footage.

Another objective of the present invention is to provide a device that would increase the weight per plant in shorter time.

A further objective of the present invention is to provide a device that would provide cost effectiveness and reduces labor cost.

A further objective of the present invention is to provide a device that would provide extendibility and portability.

Yet another object of the present invention is to provide a device that would allow increased plant growth than other organic systems.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a top perspective view of a preferred embodiment of a device showing a plurality of sheets attached together with an attachment means;

FIG. 2 is a top perspective view of a preferred embodiment of the device showing at least one sheet having a plurality of protruded openings;

FIG. 3 is a perspective view of a container like structure formed by attaching the plurality of sheets;

FIG. 4 is a top perspective view of the container like structure formed by joining the plurality of sheets showing an inner surface and an outer surface of the plurality of sheets;

FIG. 5 is a perspective view of the container like structure showing a plurality of protruded openings with an attached cover at both ends; and

FIG. 6 is a top view of the container like structure with the plurality of protruded openings.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

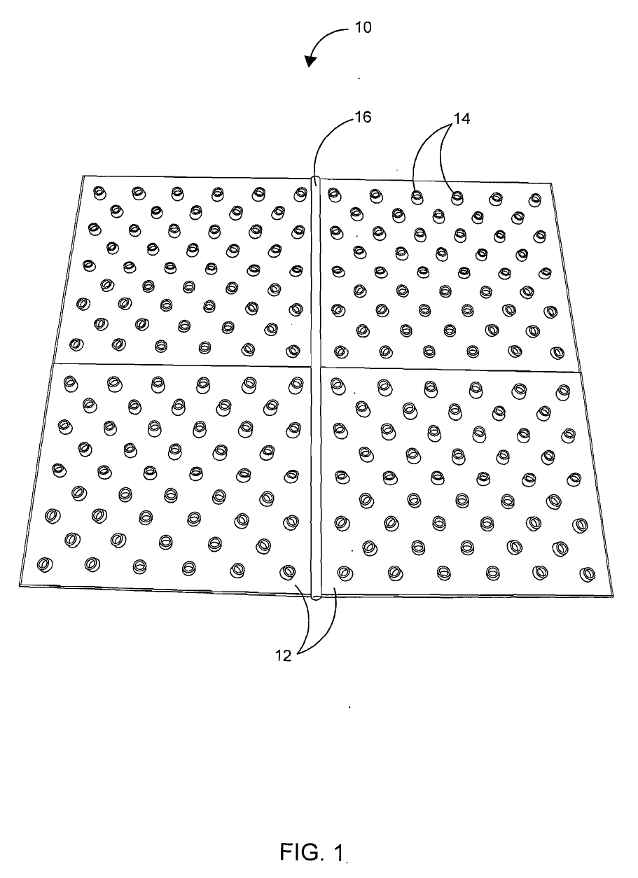

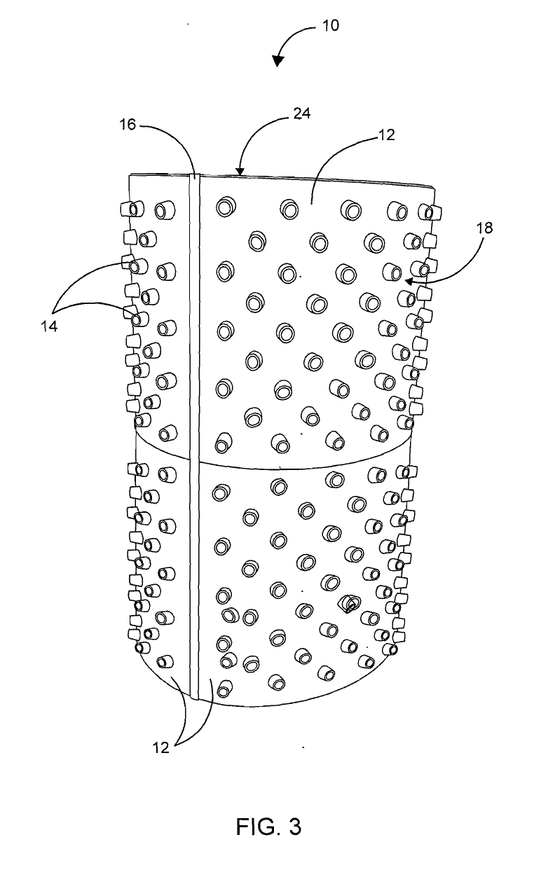

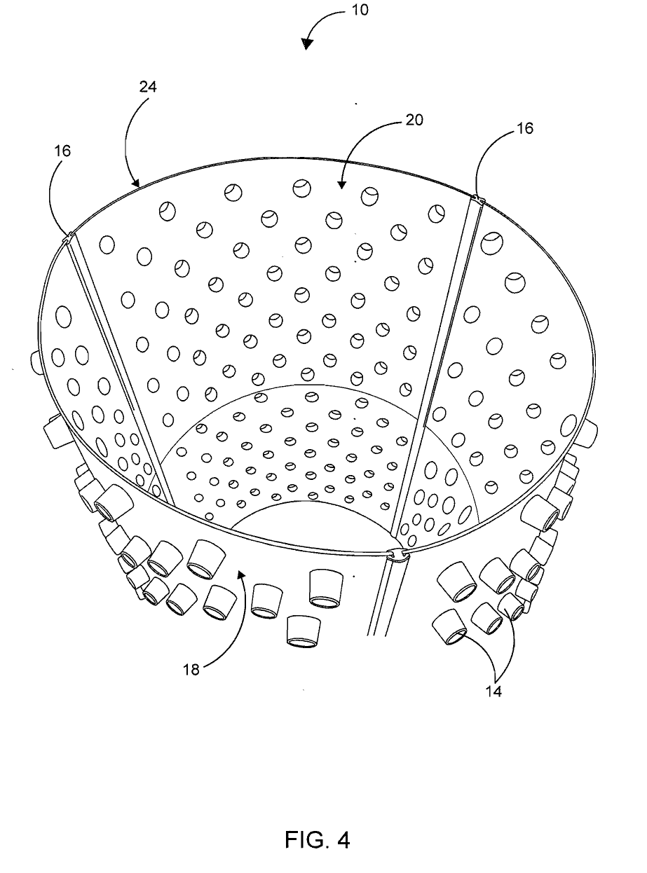

FIG. 1 is a top perspective view of the preferred embodiment of the device 10 showing a plurality of sheets 12 attached together with an attachment means 16. The device 10 comprises a plurality of sheets 12 including an outer surface 18 (See FIG. 3) and an inner surface 20 (See FIG. 4). The plurality of sheets 12 have a plurality of protruded openings 14 at the outer surface 18 (See FIG. 3) to provide circulation of air and water inside the container like structure 24 (See FIG. 3). The plurality of sheets 12 are joined together and then rolled up to form a container like structure 24 (See FIG. 3) to grow plants. The plants are grown in an aquaponic environment where no soil is required for plant growth.

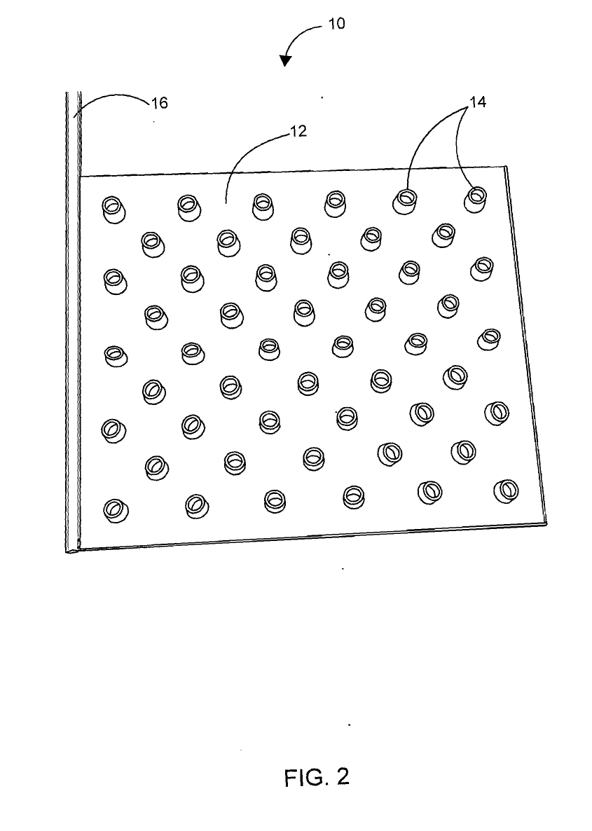

FIG. 2 is a top perspective view of the preferred embodiment of the device 10 showing at least one of the plurality of sheets 12 joined to form the container like structure 24 (see FIG. 3). The plurality of sheets 12 are attached with an attachment means 16 and rolled up to form a container like structure 24 (see FIG. 3) for growing plants in aquaponic environment. The plurality of protruded openings 14 in the plurality of plant sheets 12 is adaptable to receive plant seeds. The plurality of sheets 12 are made of polypropylene.

FIG. 3 is a perspective view of a container like structure 24 formed by attaching the plurality of sheets 12. The plurality of sheets 12 are joined together to form a container like structure 24 with an attachment means 16. The plurality of protruded openings 14 receives plant seeds and water is sprayed inside the container like structure 24 directed away from center to roots of the plants. The roots of the plants are sprayed with nutrients inside the container structure 24. The nutrients sprayed for the growth of plants may be a bio-fertilizer.

FIG. 4 is a top perspective view of the container like structure 24 formed by joining the plurality of sheets 12 showing an inner surface and an outer surface 18 of the plurality of sheets 12. The device 10 is used for growing plants and vegetables where no soil is required. The device 10 provides increased growth of plants in lesser time. The device 10 is used in combination of aquaponics and aeroponics. The material of the plurality of sheets 12 is made of polypropylene. The container like structure 24 has height of 1 meter, diameter of 60 cm and hole diameter of approximately 1 inch.

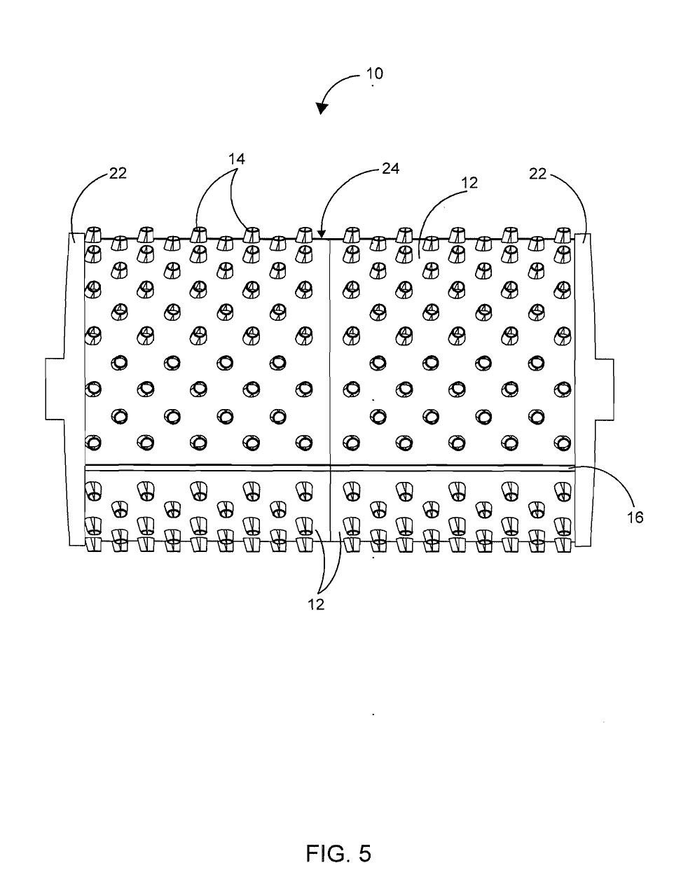

FIG. 5 is a perspective view of the container like structure 24 showing a plurality of protruded openings 14 with an attached cover 22 at both ends. The device 10 includes the plurality of sheets 12 which are rolled and attached together with an attachment means 16. Thus provides more extendibility and increased in size by attaching the plurality of sheets 12.

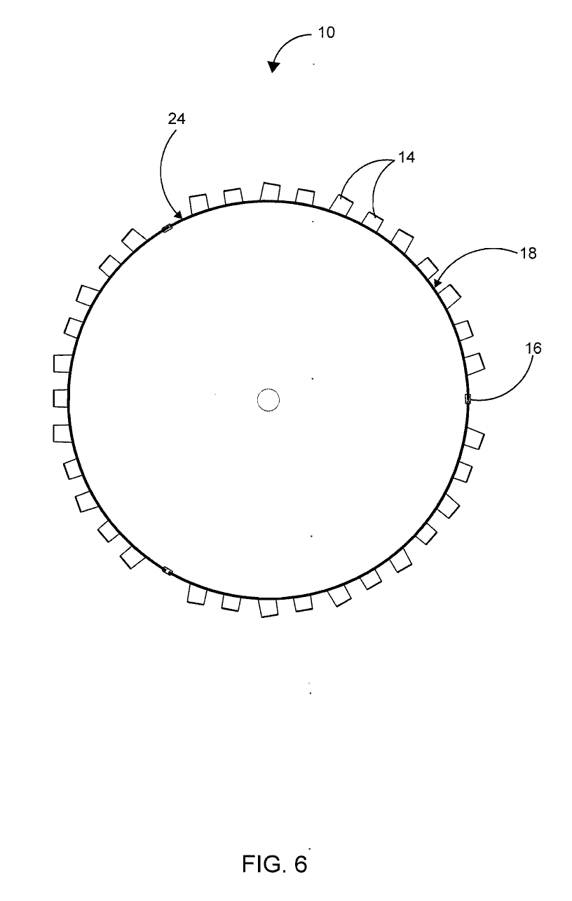

FIG. 6 is a top view of the container like structure 24 with the plurality of protruded openings 14. The device 10 provides maximum growing area in limited footage. The device 10 also provides increase in weight per plant. The device 10 helps in maximum growth of plants in shorter time which is better than the organic systems. The device 10 is suitable for growing vegetables such as lettuce, potato, tomato, strawberry etc.

The device 10 is a structure for growing vegetables and plants in aquaponic conditions. The device 10 accelerates the growth of plants and also increases the growth size of plants. The device 10 provides vertical growth of plants in shorter time. The device 10 also provides maximum growing area in limited footage. The device 10 allows portability and scalability. The device 10 allows plant growth in aquaponic environment which is better than other organic systems.

In one embodiment, a fish bowl is placed at the bottom of device 10 for catching water dripped from the container like structure. The dripped water contains bacteria that are useful for the growth of the fish. The fish uses the bacteria thereby providing cleaning of water. The ammonia generated by fish is naturally converted into nitrates that are used by plants for vigorous growth and the cycle repeats.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A device for growing plants comprising:
a plurality of sheets, each having an outer surface and an inner surface, the outer surface having a plurality of protruded openings;
whereby the plurality of sheets being attached and rolled up to form a container like structure for growing plants in aquaponic conditions.

2. The device of claim 1 wherein the plurality of sheets is attached with at least one attachment means to form the container like structure.

3. The device of claim 1 wherein the container like structure is sprayed with water directed away from the center.

4. The device of claim 1 wherein the container like structure is sprayed with nutrients directed towards roots of the plants.

5. The device of claim 4 wherein the nutrients may be a bio-fertilizer.

6. The device of claim 1 wherein the plurality of protruded openings is adaptable to insert plant seeds.

7. The device of claim 1 wherein the plurality of protruded openings provides air circulation inside the container like structure.

8. The device of claim 1 wherein the container like structure is closed with a cover on at least one end thereof.

9. The device of claim 1 wherein the plurality of sheets is made of polypropylene.

10. A method of growing plants in an aquaponic environment, the method comprising the steps of:
a) providing a plurality of sheets having a plurality of protruded openings on an outer surface;
b) attaching the plurality of sheets and rolled up to form a container like structure;
c) inserting plant seeds into the plurality of protruded openings;
d) spraying water inside the container like structure from center outward; and
e) spraying nutrients to roots of plants inside the container like structure.

11. The method of claim 10 wherein the plurality of sheets is attached with at least one attachment means to form the container like structure.

12. The method of claim 10 wherein the plurality of protruded openings is adaptable to receive plant seeds.

13. The method of claim 10 wherein the nutrients may be a bio-fertilizer.

14. The method of claim 10 wherein the plurality of sheets is made of polypropylene.

15. The method of claim 10 wherein the container like structure is closed with a cover on at least one end thereof.
